(19) United States
(12) Patent Application Publication
(10) Pub. No.: US 2008/0206410 A1
(43) Pub. Date: Aug. 28, 2008

(54) Liquid Egg Material

(76) Inventors: John D. Efstathiou, Plymouth, MN (US); Alexander Patist, Shakopee, MN (US); Robert Ralph Prochnow, Dellwood, MN (US)

Correspondence Address: Christopher M. Turoski;Cargill, Incorporated, Law Department, P.O. Box 5624, Minneapolis, MN, 55440-5624, US

(21) Appl. No.: 11/887,665

(22) PCT Filed: Mar. 31, 2006
(86) PCT No.: PCT/US2006/012357

§ 371 Date: Sep. 28, 2007

Related U.S. Application Data
(60) Provisional application No. 60/668,138, filed on Apr. 4, 2005.
(60) Provisional application No. 60/726,308, filed on Oct. 13, 2005.

(51) Int. Cl. A23B 5/00; A23L 1/32; A23L 3/30; A23L 1/025

(52) U.S. Cl. 426/238; 426/614

(57) ABSTRACT

Described are homogenized liquid egg products, which may be prepared by subjecting liquid whole egg material to sufficient ultrasonic energy to prepare a homogenized liquid egg product. Also disclosed are methods for treating liquid egg material with ultrasonic energy to prepare homogenized liquid egg products.

### CROSS-REFERENCE TO RELATED APPLICATIONS

The present application claims the benefit of U.S. provisional application No. 60/668,138, filed on Apr. 4, 2005; and U.S. provisional application No. 60/726,308, filed on Oct. 13, 2005, which applications are incorporated herein by reference in their entireties.

### BACKGROUND

The present invention relates generally to the field of liquid egg products and materials. Liquid egg products are useful in the food industry as a replacement for whole eggs and may be used to prepare a wide variety of egg products or food products that contain egg. Liquid egg products may be used in many situations where fresh eggs would normally be used.

Typically, liquid eggs are prepared as a stable, homogenized liquid egg product, such that the product does not separate under normal storage conditions. Homogenization is an industrial process whereby a fat emulsion, such as liquid whole egg, is subjected to high shear mixing to shear or split the largest fat globules into smaller fat globules and by such means the fat emulsion is stabilized.

Homogenization normally takes place by mechanical processing. In one common homogenization process, liquid egg material is mixed by subjecting the liquid egg material to high pressure. Liquid egg material at high in-feed pressure is passed through a narrow gap such that turbulence is created within the liquid egg material. The turbulence shears the fat globules in the liquid egg material. In addition, cavitation bubbles are created in the liquid egg material, which implode and break up fat globules. The result is a product that consists of a stable emulsion.

Homogenization procedures may also include rotar-stator mixing. Like high pressure mixing, rotar-stator mixing subjects liquid eggs to high shear conditions and creates cavitation bubbles in the liquid eggs such that fat globules are broken up to produce a stable emulsion. Because high pressure mixing and rotar-stator mixing have high energy requirements, require high capital expenditures, and result in products that may not exhibit consistent stability, new methods for preparing homogenized liquid egg products are desirable.

### SUMMARY

Described herein is a homogenized liquid egg product. The product typically includes at least about 60% (w/w) liquid whole egg. In some embodiments, the product includes at least about 70%, 80%, 90%, 95%, 99%, or 100% (w/w) liquid whole egg. In some embodiments, the product includes about 60-80%, 60-90%, 70-90%, or 80-90% (w/w) liquid whole egg.

The product typically does not include more than about 0.2% (w/w) stabilizer or emulsifier (e.g., as gum stabilizer). In some embodiments, the product does not include more than about 0.15%, 0.1%, 0.05%, or 0.025% (w/w) stabilizer or emulsifier. In other embodiments, the product does not include stabilizer or emulsifier.

The product may include water. For example, the product may include about 10-40% water. In other embodiments, the product includes about 10-20% water.

Typically, the product is fully homogenized and does not substantially separate. In one embodiment, the product has a “separation factor” of no more than about 3% (v/v), as determined after the product has been stored for at least about 2, 3, 4, or 5 days (or at least about 1, 2, 4, 8, or 16 weeks), at a temperature of about 2-10° C. (˜36-50° F.), and commonly about 4° C. (˜40° F.). In other embodiments, the product has a “separation factor” of no more than about 2.5%, 2%, 1%, or 0.5% (v/v). A “separation factor” may be calculated by subjecting a homogenized liquid egg product to a centrifugal or gravitational force, and then subsequently measuring the volume of supernatant separated from the product relative to the total volume of the product to determine a percentage.

The product typically has a viscosity of about 10-700 cps. In some embodiments, the product has a viscosity of about 10-500 cps, about 10-350 cps, about 50-350 cps, or about 50-150 cps. The viscosity of the product may be increased by adding stabilizer or emulsifier (e.g., by adding gum stabilizer). For example, a product having about 0.1-0.2 wt. % gum stabilizer may have a viscosity of about 100-150 cps. A product having about 0.05 wt. % gum stabilizer may have a viscosity of about 40 cps.

The product may include liquid egg white material. In some embodiments, the product includes about 5-20% or 15-20% (w/w) liquid egg white material.

The product may include milk material, which may include buttermilk and/or whey solids. In some embodiments, the product includes abouve 0.5-3.0% (w/w) milk material.

The product may include anti-microbial agents. In some embodiments, the product includes about 20-1000 ppm nisin, and commonly about 20-500 ppm nisin, 20-200 ppm nisin, or about 20-100 ppm nisin.

The product typically has a pH of about 6.3-7.3, and commonly about 6.5-7.0. In some embodiments, the product has a pH of about 6.5-6.7, about 6.5-6.8, or about 6.6-6.8. The product may include agents that adjust the pH of the product (e.g., acidifying agents such as citric acid and/or buffering agents such as sodium acid pyrophosphate (“SAPP”)).

In some embodiments, the product includes no more than about 1.6% (w/w) total carbohydrate. In other suitable embodiments, the product includes no more than about 1.55%, 1.5%, 1.45%, 1.4%, 1.35%, 1.3%, 1.25%, 1.2%, 1.15%, 1.1%, 1.05%, or 1% (w/w) total carbohydrates.

In some embodiments, the product includes: (a) about 80-90% (w/w) liquid whole egg; (b) about 10-20% (w/w) water; and (c) no more than about 0.15% (w/w) gum stabilizer. The product may have a viscosity of about 20-1000 cps; a pH of about 6.3-7.3; and a separation factor of no more than about 2.5% (v/v) as determined after the product has been stored for about 2 days at about 2-10° C. (˜36-50° F.), and commonly about 4° C. (˜40° F.). The pro duct may include about 20-500 ppm antimicrobial agent such as nisin. Optionally, the product includes no more than about 1.25% (w/w) total carbohydrate, and preferably no more than about 1.2% (w/w) total carbohydrate.

In other embodiments, the product includes: (a) about 65-75% (w/w) liquid whole egg; (b) about 10-20% (w/w) liquid egg white material; and (c) no more than about 0.15% (w/w) gum stabilizer. The product may have a viscosity of about 10-500 cps; a pH of about 6.3-7.3; and a separation factor of less than about 2.5% (v/v) as determined after the product has been stored for about 2 days at about 2-10° C. (˜36-50° F.), and commonly about 4° C. (˜40° F.). The pro duct may include about 0.5-3.0% (w/w) liquid or dried milk material (e.g., buttermilk and/or whey solids). The product may include about 20-500 ppm anti-antimicrobial agent such as nisin.

In another embodiment, the product includes: (a) at least about 95%, 96%, 97%, 98%, or 99% (w/w) liquid whole egg; and (b) no more than about 0.2%, 0.15%, 0.1%, 0.05%, or 0.025% (w/w) gum stabilizer. In a further embodiment, the product does not include gum stabilizer. The product typically has a separation factor of no more than about 3%, 2%, 1%, or 0.5% (v/v) as determined after storing the product for at least about 2, 3, 4, or 5 days (or as determined after storing the product for at least about 1, 2, 4, 8, or 16 weeks), at a temperature of about 2-10° C. (˜36-50° F.), and commonly about 4° C. (˜40° F.). The product may have a viscosity of about 10-500 cps and a pH of about 6.3-7.3. The product may include about 20-500 ppm anti-antimicrobial agent such as nisin. Optionally, the product includes no more than about 1.5% (w/w) total carbohydrates. In other suitable embodiments, the product includes no more than about 1.45%, 1.4%, 1.35%, 1.3%, 1.25%, 1.2%, 1.15%, 1.1%, 1.05%, or 1% (w/w) total carbohydrates.

Also described herein is a method for preparing a homogenized liquid egg product. The method includes subjecting liquid egg material to sufficient ultrasonic energy to prepare a homogenized liquid egg product. The liquid egg material typically includes at least about 60% (w/w) liquid whole egg. The method may be used to prepare homogenized liquid egg products that have a separation factor of no more than about 3%, 2.5%, 2.0%, 1.5%, 1.0%, or 0.5% (v/v) as determined after storing the products have for at least about 2, 3, 4, or 5 days (or as determined after storing the product for at least about 1, 2, 4, 8, or 16 weeks), at a temperature of about 2-10° C. (˜36-50° F.), and commonly about 4° C. (˜40° F.).

The liquid egg product used in the method may include a stabilizer or emulsifier (e.g., a gum stabilizer). In some embodiments, the liquid product includes no more than about 0.2%, 0.15%, 0.1%, or 0.05% (w/w) stabilizer or emulsifier. Optionally, the product includes no more than about 1.5%, 1.45%, 1.4%, 1.35%, 1.3%, 1.25%, 1.2%, 1.15%, 1.1%, 1.05%, or 1% (w/w) total carbohydrates.

In the method, the liquid egg product may be maintained at a desirable temperature. For example, the liquid egg product may be maintained at a temperature of about 2-10° C. (˜36-50° F.), while the liquid egg product is subjected to ultrasonic energy.

The method typically includes subjecting the liquid egg material to about (1×10⁻⁴-1×10⁻¹) kilowatt-hour ultrasonic energy per liter liquid egg product. In some embodiments, the method includes subjecting the liquid egg material to about (1×10⁻⁴-1×10⁻²) kilowatt-hour ultrasonic energy per liter liquid egg product, or about (1×10⁻⁴-1×10⁻³ ) kilowatt-hour ultrasonic energy per liter liquid egg product.

The ultrasonic energy typically has a frequency of about at least about 15 kHz and commonly the ultrasonic energy has a frequency of about 15-100 kHz or 16-100 kHz. In some embodiments, the ultrasonic energy has a frequency of about 20-50 kHz.

In the method, the liquid egg material typically is subjected to ultrasonic energy for about 2-60 seconds. In some embodiments, the liquid egg material is subjected to ultrasonic energy for about 4-30 seconds or about 4-10 seconds.

The ultrasonic energy typically has a power within a range of about 0.2-60 kW. In some embodiments, the ultrasonic energy has a power within a range of about 0.2-20 kW, about 0.2-30 kW, or about 0.4-15 kW. The ultrasonic energy may be provided by transducers having discrete powers of 1 kW, 2 kW, 4 kW, 8 kW, 16 kW, or combinations and multiples thereof.

The liquid egg material may be pasteurized before, during, or after being subjected to ultrasonic energy. In some embodiments, the liquid egg material is pasteurized after the liquid egg material is subjected to ultrasonic energy. The liquid egg material may be pasteurized by subjecting the liquid egg material to sufficient heat and/or pressure. In some embodiments, the liquid egg material may be heated to about 60-65° C. (˜140-150° F.) for about 1-5 minutes. In some embodiments, the liquid egg material may be treated with pressure of at least about 300 mPa (˜45,000 psi) for about 1-5 minutes.

The homogenized liquid egg product (“HLEP”) typically includes fat and other fat material which are present as particles in an emulsified phase of the product. The HLEP particles may be analyzed to characterize the emulsion in terms of particle characteristics, such as mean equivalent spherical diameter (“ESD”) as measured in microns, mean aspect ratio (“A/R”), mean sphericity, and mean shape. In some embodiments, the homogenized liquid egg product includes particles that may have one or more of the following particle characteristics related to mean ESD, mean A/R, and mean sphericity: a mean ESD of no more than 4.2 microns (or suitably no more than 4.0 microns, 3.8 microns, 3.6 microns, or 3.4 microns); a mean A/R of no more than 0.71 (or suitably no more than 0.69, 0.68, 0.67, 0.66 or 0.65); and a mean sphericity or no more than 0.61 (or suitably no more than 0.60, 0.59, 0.58, 0.57, 0.56 or 0.55).

### DETAILED DESCRIPTION

The present method relates to homogenization of liquid egg products that include liquid whole egg. The term “liquid whole egg,” as used in this disclosure, means a mixture of egg white and yolk. The liquid whole egg may, but does not necessarily, include egg white and egg yolk in a ratio recognized as the ratio of yolk to white in egg shells. Liquid whole egg products may include other “additives” such as salts or buffers (e.g., sodium chloride, sodium acid pyrophosphate (SAPP), monosodium phosphate (MSP), monosodium glutamate (MSG)), sugar, anti-microbial agents (e.g., nisin), thickening agents (e.g., starch and in particular cornstarch or modified cornstarch), stabilizing agents (e.g., xanthan gum), and acidifying agents (e.g., citric acid).

The term “liquid egg white,” as used in this disclosure, means egg white obtained after separating the white and the yolk by breaking fresh eggs, and as such, the liquid egg white is substantially free of egg yolk. The liquid egg white may be used in products that include other “additives” as describe above.

The term “liquid egg yolk,” as used in this disclosure, means egg yolk obtained after separating the yolk and the white by breaking fresh eggs, and as such, the liquid egg yolk is substantially free of egg white. The liquid egg yolk may be used in other products that include other “additives” as described above.

As used herein, “separation factor” means the volume percentage of the product that separates from the original volume of the product, after the product has been stored for a period of time. The product may be stored at a temperature of about 2-10° C. (36-50° F., and commonly about 4° C. (˜40° F.). The “separation factor” may be used to characterize the stability of a homogenized product after storing the product for any selected period of time (e.g., at least about 2, 3, 4, or 5 days or at least about 1, 2, 4, 8, or 16 weeks). As used herein, a “separation factor” is calculated by subjecting the product to a G-force of about 1000-2600×g for at least about 5 minutes, (commonly about 1600-2000×g for at least about 5 minutes, and more commonly about 1800×g for about 5 minutes).

As used herein, “ultrasonic energy” means mechanical, vibratory energy that operates at frequencies greater than audible sound. “Ultrasonic energy” has a frequency that is inaudible to the human ear, typically at least about 10 kHz, and more typically at least about 16 kHz or at least about 20 kHz. “Ultrasonic energy” imparted to a liquid is capable of generating compression waves in the liquid and causing cavitation.

As used herein, “total carbohydrates” includes monosaccharides and polysaccharides (e.g., disaccharides). Polysaccharides include storage polysaccharides (e.g., starches) and structural polysaccharides (e.g., fibers).

The term “food grade,” as used herein, means that up to specified amount of the specified agent (e.g., an antimicrobial agent that includes a single compound or a mixture of compounds) can be ingested by a human without generally causing deleterious health effects. Examples of food grade agents include those additives “generally recognized as safe” (“GRAS”) by the United States Food and Drug Administration (“FDA”) and colorants approved by the FDA for use in foods for human consumption. In particular, food grade additives includes those compounds (or mixtures of compounds) listed as approved under 21 C.F.R. §§ 73, 74, 172, 182 and 184 as well as other compounds recognized by comparable regulatory authorities in other countries.

The homogenized liquid egg product (“HLEP”) typically includes fat and other fat material which are present as particles in an emulsified phase of the product (i.e., “HLEP particles” or “particles”). The HLEP particles may be analyzed to characterize the emulsion in terms of particle characteristics, such as mean equivalent spherical diameter (“ESD”) as measured in microns, mean aspect ratio (“A/R”), mean sphericity, and mean shape.

The terms “Equivalent Spherical Diameter” (“ESD”) or “Heywood Diameter” (“DH”), as used herein, relates to a size-related measurement that is defined as the diameter of a sphere having the same volume as the particle under analysis. ESD or DH may be calculated according to the formula in Scheme 1. In some embodiments, homogenized liquid egg products described herein may have a mean ESD of no more than 4.2 microns (or suitably no more than 4.0 microns, 3.8 microns, 3.6 microns, or 3.4 microns).

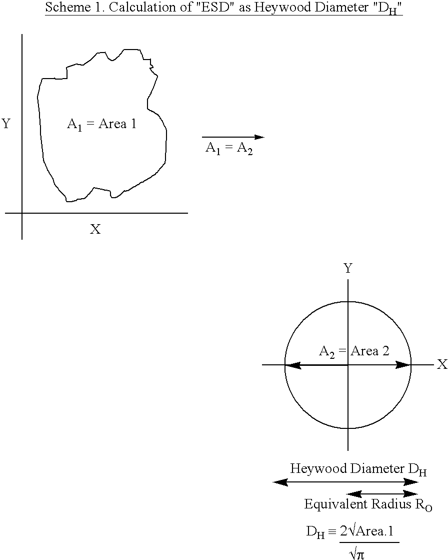

As used herein, the term “Aspect Ratio” relates to a shape-related measurement that is defined as the ratio of the diameter located perpendicular to the maximum diameter (i.e., Aspect Diameter), to the maximum diameter. The Aspect Ratio (“AIR”) may be calculated as a Feret Aspect Ratio using the formula provided in Scheme 2. In some embodiments, homogenized liquid egg products described herein may have a mean A/R of no more than 0.71 (or suitably no more than 0.69, 0.68, 0.67, 0.66 or 0.65).

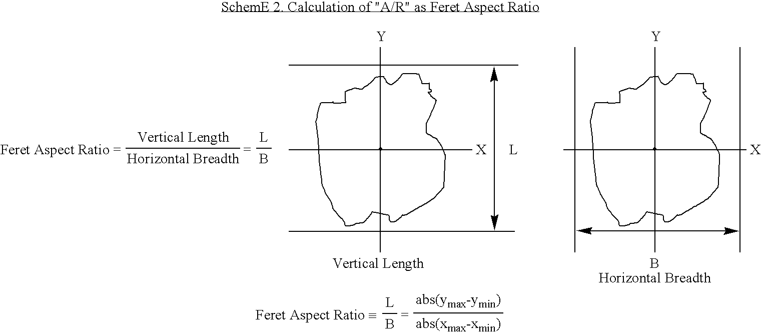

As used herein, the term “sphericity” relates to a shape-related measurement that is defined as 4π times the ratio of the particle projected area to the square of the particle perimeter. The sphericity of a circle is one. “Sphericity” may be calculated using the formula provided in Scheme 3. In some embodiments, homogenized liquid egg products described herein may have a mean sphericity or no more than 0.61 (or suitably no more than 0.60, 0.59, 0.58, 0.57, 0.56 or 0.55).

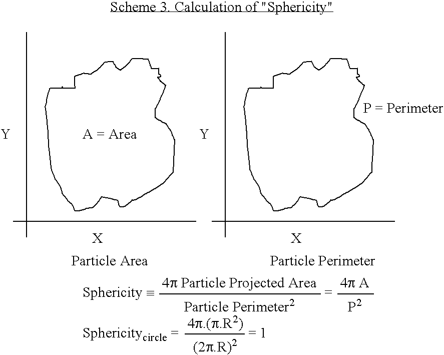

As used herein, the term “shape” relates to a pattern of all the points on the boundary of a particle. “Shape” also may be defined as the size-normalized variance of the radial distribution of the particle profile, representing the amount of deviation between the radii of a particle profile and the radii of a circle. The shape of a circle is zero since the radius of a circle at any angle θ is a constant. Therefore, the circle is the reference point from which all shape is measured. “Shape” may be calculated using the formulas provided in Scheme 4.

Scheme 4. Calculation of “Shape”

$$\begin{matrix} Shape ≡ {\sum }_{n = 1}^{∞} {L}_{2 , n}^{2} where \\ {L}_{2 , n} = \frac{\sqrt{{a}_{n}^{2} + {b}_{n}^{2}}}{{R}_{0}} and {R}_{0} = \sqrt{{a}_{0}^{2} + \frac{1}{2} {\sum }_{n = 1}^{∞} {a}_{n}^{2} + {b}_{n}^{2}} \\ n = 1 , 2 , 3 , …∞\end{matrix}$$

As a morphological statistical feature

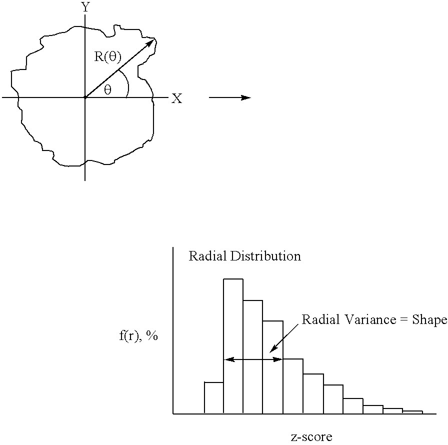

$$Shape = \frac{{\sum }_{i = 1}^{N} {( {r}_{i} - \overline{r} )}^{2}}{( N - 1 ) \sqrt{\frac{Area}{π}}}$$

“Size Normalized Variance of the Particle Radial Distribution”

Described herein is a method for preparing a homogenized liquid egg product. As indicated, a variety of liquid egg products may be suitable for the described methods of homogenization. For example, liquid egg products, such as liquid whole eggs, mixtures of liquid egg whites and liquid egg yolks, and/or concentrated liquid egg products may be suitable for the methods. The liquid egg products may include additional ingredients such as salts and/or buffers (e.g., sodium chloride, SAPP, MSP, and/or MSG), water, thickening/stabilizing/emulsifying agents (e.g., xanthan gum, carrageenan), milk products (e.g., butter milk and/or nonfat milk, which may be liquid and/or dried), edible oils (e.g., soybean oil), flavors (e.g., butter, pepper, egg, and/or MSG), acidifying agents (e.g., citric acid to achieve a pH of about 6.7 to about 6.8), chelating agents (e.g., EDTA), antimicrobial agents (e.g., Nisin), and/or flavoring agents.

The product typically includes at least about 60% (w/w) liquid whole egg. In some embodiments, the product includes at least about 70%, 80%, 90%, 95%, 99%, or 100% (w/w) liquid whole egg. In some embodiments, the product includes about 60-80%, 60-90%, or 70-90% (w/w) liquid whole egg.

The product may include additional egg components. For example, the product may include liquid or dried egg white and/or liquid or dried egg yolk. In one embodiment, the product may have a ratio of liquid egg white and liquid egg yolk that is recognized as in egg shells, or alternatively, the product may have a ratio of liquid egg white and liquid egg yolk that is not recognized as in egg shells. In some embodiments the product may include about 5-20% or 15-20% (w/w) liquid egg white material.

A stabilizer or emulsifier may be present in the homogenized liquid whole egg. Stabilizers and emulsifiers may include gum stabilizers. Gum stabilizers include natural and synthetic gums. As used herein, “gum stabilizer” includes xanthan gum, carrageenan, guar gum, locust bean gum, pectin, gellan gum, gelatin, gum Arabic, gum karay, gum tragacanth, gum ghatti, agar, konjac, alginate, tara gum, pullulan, curdlan, chitosan, carboxymethylcellulose gum, cellulose, microcrystalline cellulose, methylcellulose, hydroxypropyl methylcellulose, and mixtures thereof. The product typically does not include more than about 0.20% (w/w) stabilizer or emulsifier. In some embodiments, the product does not include more than about 0.15%, 0.1%, 0.05%, or 0.025% (w/w) stabilizer or emulsifier. In another embodiment, the product does not include stabilizer or emulsifier. Optionally, the product includes no more than about 1.5%, 1.45%, 1.4%, 1.35%, 1.3%, 1.25%, 1.2%, 1.15%, 1.1%, 1.05%, or 1% (w/w) total carbohydrates.

Typically, the product is fully homogenized and does not substantially separate. In one embodiment, the product has a “separation factor” of no more than about 3% (v/v) after the product has been stored for at least about 2 days. In other embodiments, the product has a separation factor of no more than about 2%, 1%, or 0.5% (v/v), after the product has been stored for at least about 2 days. The separation factor for a product may be determined by subjecting the product to a gravitational force (i.e., G-force). For example, the separation factor for a product may be determined by subjecting the product to a centrifugal G-force of about 1000-2600×g for at least about 5 minutes. Preferably, the separation factor is determined by subject the product to a centrifugal G-force of about 1600-2000×g for about 5 minutes, (more preferably about 1800×g for about 5 minutes). Typically, the separation factor for a product will be assessed after the product has been stored at about 2-10° C. (˜36-50° F.), for a selected period of time (e.g., about 24-72). The G-force (or relative centrifugal force) may be calculated according to the following formula: G-force=1.119×(rpm)²×r, where “rpm” is rotations per minute and “r” is the radius of the rotor. G-force may be reported as “N×g” (i.e., as multiples of the earth's gravitation force where “g” is the earth's gravitation force). After having been subjected to a sufficient G-force, the product may separate into one or more layers. For example, the product may include a supernatant layer on the surface of the product. A separation factor can be determined by measuring the volume of the supernatant layer relative to the volume of the entire product and calculating a percentage.

The product typically has a viscosity of about 10-700 cps. In some embodiments, the product has a viscosity of about 10-500 cps, about 10-350 cps, about 50-350 cps, or about 50-150 cps. Typically, the product has a viscosity that makes the product suitable for use in preparing a cooked egg product. The viscosity of a product may be increased by adding thickening agents. Thickening agents may include stabilizers, emulsifiers, starches, and mixtures thereof. For example, the product may obtain a viscosity of about 100-150 cps by adding about 0.2 wt. % xanthan gum, or the product may obtain a viscosity of about 50 cps by adding about 0.05 wt. % xanthan gum. Suitable starches may include natural or modified starches, including food starches such as cornstarch, waxy cornstarch, rice starch, wheat starch, tapioca starch, potato starch, arrowroot starch, maize starch, oat starch, and mixtures thereof.

The product may include milk material. In some embodiments, the product includes buttermilk and/or whey solids. The milk material may include liquid material, dried milk material, or both. In some embodiments, the product includes about 0.5-3.0% (w/w) milk material.

Antimicrobial agents may be added to the product to extend shelf life. Antimicrobial agents may be used to kill organisms in the product (i.e., cidal agents) or to retard the growth of organisms in the product (i.e., static agents). The antimicrobial agent added to the egg product is typically food grade material. One particularly suitable antimicrobial agent is nisin, which is a bacteriocin produced by Lactococcus lactis subsp. lactis. Nisin consists of a short peptide (34 a. a.) that includes atypical amino acids. Nisin may be added to the egg product in any effective concentration to extend the shelf life of the egg product. For example, suitable concentrations maybe about 50 to about 1000 ppm; about 100 ppm to about 500 ppm; about 150 ppm to about 350 ppm, and commonly about 50 ppm.

The product typically has a pH of about 6.3-7.3, commonly about 6.5-7.0. In some embodiments, the product has a pH of about 6.5-6.7, 6.5-6.8 or about 6.6-6.8. The product may include agents that adjust the pH of the product (e.g., acidifying agents such as citric acid and/or buffering agents such as sodium acid pyrophosphate (“SAPP”)).

Also described herein is a method for preparing a homogenized liquid egg product. The method includes subjecting liquid egg material to sufficient ultrasonic energy to prepare a homogenized liquid egg product. The liquid egg material may be subjected to ultrasonic energy generated by any suitable system. Systems for generating ultrasonic energy are available from commercial sources (e.g., Hielscher GmbH, Teltow, D E). The ultrasonic energy generated by these systems typically has a frequency of about 15-100 kHz. In some embodiments, the ultrasonic energy has a frequency of about 20-50 kHz. Systems may be devised that include transducer which provide discrete power units (e.g., 1 kW, 2 kW, 4 kW, 8 kW, 16 kW, or combinations and/or multiples thereof). Generally, these systems utilize one of two types of probes for administering ultrasonic energy (i.e., “sonotrodes”). These include axial probes and radial probes, either of which are suitable for the method described herein. Desirably, the probe is an axial probe.

The method typically includes subjecting the liquid egg material to about (1×10⁻⁴-1×10⁻¹) kilowatt-hour ultrasonic energy per liquid egg product (i.e., joules per liter liquid egg material). In some embodiments, the method includes subjecting the liquid egg material to about (1×10⁻⁴-1×10⁻²) kilowatt-hour ultrasonic energy per liquid egg product, or about (1×10⁻¹-1×10⁻³) kilowatt-hour ultrasonic energy per liquid egg product. Commercial systems typically allow the user to vary the power of the ultrasonic energy and the “hold time” for the sample, (i.e., the amount of time that the sample is exposed to the ultrasonic energy). The power and/or hold time may be inversely varied to administer a desirable amount of energy to a volume of the liquid egg material. For example, the liquid egg material may be subjected to ultrasonic energy having power P₁ for a hold time H₁. Alternatively, the liquid egg material may be subject to ultrasonic energy having power P₂ for a hold time H₂, where P₁(H₁)=P₂(H₂). Typically, the ultrasonic energy may have a power that varies from about 0.2-20 kW, (or desirably 0.4-2.0 kW), and the liquid egg material is subjected to ultrasonic energy for about 5-120 seconds, (or desirably for about 10-90 or 15-60 seconds).

In the method, it may be desirable to maintain the liquid egg material at a temperature of about 2-10° C. (˜36-50° F.). For example, the liquid egg material may be maintained at a temperature of 2-10° C. (˜36-50° F.) while the liquid egg material is subjected to ultrasonic energy. In one embodiment, the liquid egg material is maintained at a relatively low temperature while the liquid egg material is subject to ultrasonic energy in order to prevent the liquid egg material from being cooked (i.e., to prevent proteins in the liquid egg material from becoming denatured).

The method typically results in a homogenized liquid egg product that has a separation factor of no more than about 3% (v/v), which may be determined as described above. In other embodiment, the method results in a homogenized liquid egg product that has a separation factor of no more than about 2.5%, 2.0%, 1.5%, 1.0%, or 0.5% (v/v).

In the method, the liquid egg product typically includes at least about 60% liquid whole egg. The liquid egg product may include at least about 70%, 80%, 90%, 95%, or 99% liquid whole egg. In some embodiments, the liquid egg product include about 60-80%, 60-90%, or 70-90% (w/w) liquid whole egg. The liquid egg material may include additional non-whole egg components. For example, the liquid egg material may include egg white (liquid or dried), egg yolk (liquid or dried), or a mixture thereof. In one embodiment, the liquid egg material includes about 65-75% (w/w) liquid whole egg and further includes about 10-20% (w/w) liquid egg white.

The liquid egg product prepared by the method may include a stabilizer or emulsifier (e.g., a gum stabilizer). In some embodiments, the liquid product includes no more than about 0.2%, 0.15%, 0.1%, or 0.05% (w/w) stabilizer. The stabilizer or emulsifier may be added at any step in the method, (i.e., before, during, or after subjecting the liquid egg material to ultrasonic energy).

The liquid egg product prepared by the method has a viscosity of about 20-700 cps. Any suitable thickening agent (e.g., stabilizers and/or emulsifiers) may be added at any step of the method to obtain a product with a suitable viscosity (i.e., before, during, or after subjecting the liquid egg material to ultrasonic energy). Gum stabilizers as described herein may be added to obtain a product that has a suitable viscosity. Other thickening agents may be added as desirable (e.g., starches such as modified corn starch).

The liquid egg product may have a desirable pH (e.g., about 6.3-7.3 or about 6.5-6.8). Acidifying agents (e.g., citric acid) and/or buffering agents (e.g., SAPP) may be added at any step in the method to obtain a desirable pH (i.e., before, during, or after subjecting the liquid egg material to ultrasonic energy).

In the method, the liquid egg material may be pasteurized before, during, or after being subjected to ultrasonic energy. In some embodiments, the liquid egg material is pasteurized after the liquid egg material is subjected to ultrasonic energy. The liquid egg material may be pasteurized by subjecting the liquid egg material to sufficient pressure, irradiation, and/or heat. In one embodiment, the liquid egg material may be treated with pressure of at least about 300 mPa (˜45,000 psi) for about 1-5 minutes. In another embodiment, the liquid egg material may be exposed to electromagnetic radiation (e.g., gamma irradiation and/or electron beam particles) for about 1-5 minutes. In a further embodiment, the liquid egg material may be heated to temperatures of about 50° C. (˜120° F.) to about 65° C. (˜150° F.) for about 1-5 minutes, (more commonly about 60-65° C. (˜140-150° F.) for about 1-5 minutes).

The illustrative embodiments and examples described below exemplify homogenized liquid egg products and suitable liquid egg products, which may be treated with ultrasonic energy to provide homogenized liquid egg products.

### ILLUSTRATIVE EMBODIMENTS

In one embodiment, the homogenized liquid egg product includes:
(a) about 80-90% (w/w) liquid whole egg;
(b) no more than about 0.2% (w/w) gum stabilizer; and
the product has a separation factor of no more than about 2.5% (v/v) as determined after storing the product for about 2 days at a temperature of about 4° C. (˜40° F.). Optionally, the product has a separation factor of no more than about 2% (v/v) or about 1% (v/v). Optionally, the product has a viscosity of about 20-1000 cps. Optionally, the product has a pH of about 6.3-7.3 (preferably 6.5-6.8). Optionally, the product includes about 20-500 ppm nisin or 20-200 ppm nisin. In other suitable embodiments, the product includes no more than about 0.15%, 0.1%, or 0.05% (w/w) gum stabilizer. In a further embodiment, the product does not include gum stabilizer. Optionally, the product includes no more than about 1.5%, 1.45%, 1.4%, 1.35%, 1.3%, 1.25%, 1.2%, 1.15%, 1.1%, 1.05%, or 1% (w/w) total carbohydrates.

In another embodiment, the homogenized liquid egg product includes:
(a) about 65-75% (w/w) liquid whole egg;
(b) no more than about 0.2% (w/w) gum stabilizer; and
the product has a separation factor of no more than about 2.5% (v/v) as determined after storing the product for about 2 days at a temperature of about 4° C. (˜40° F.). Optionally, the product has a separation factor of no more than about 2% (v/v) or about 1% (v/v). Optionally, the product has a viscosity of about 10-500 cps. Optionally, the product has a pH of about 6.3-7.3, (preferably 6.5-6.8). Optionally, the product includes about 20-500 ppm nisin or 20-200 ppm nisin. In other suitable embodiments, the product includes no more than about 0.15%, 0.1%, or 0.05% (w/w) gum stabilizer. In a further embodiment, the product does not include gum stabilizer. Optionally, the product includes no more than about 1%, 0.95%, 0.9%, 0.85%, 0.8%, 0.75%, 0.7%, or 0.65% (w/w) total carbohydrates.

In another embodiment, the homogenized liquid egg product includes:
(a) at least about 95% (w/w) liquid whole egg; and
(b) no gum stabilizer; and
the product has a separation factor of no more than about 3% (v/v) as determined after storing the product for at least about 5 days at a temperature of about 4° C. (˜40° F.). Optionally, the product has a separation factor of no more than about 2% (v/v) or about 1% (v/v). In a suitable embodiment, the product has a separation factor of about zero, (i.e., the product exhibits no settling). Optionally, the product has a viscosity of about 10-500 cps. Optionally, the product has a pH of about 6.3-7.3, (preferably 6.5-6.8). Optionally, the product includes about 20-500 ppm nisin or 20-200 ppm nisin. Optionally, the product includes no more than about 1.3%, 1.25%, 1.2%, 1.15%, 1.1%, 1.05%, or 1% (w/w) total carbohydrates.

In another embodiment, the homogenized liquid egg product includes:
(a) about 80-89% (w/w) liquid whole egg;
(b) no more than about 0.2% (w/w) gum stabilizer; and
the product has a separation factor of no more than about 3% (v/v). Optionally, the product has a separation factor of no more than about 2% (v/v) or about 1% (v/v). In a suitable embodiment, the product has a separation factor of about zero, (i.e., the product exhibits no settling). The separation factor may be determined after storing the product for at least about 5 days at a temperature of about 4° C. (˜40° F.). Optionally, the separation factor is determined after storing the product for at least about 1 week or 2 weeks. In a suitable embodiment, the separation factor is determined after storing the product for at least about 4 weeks. Optionally the product includes no more than about 0.15% (w/w) or about 0.1% (w/w) gum stabilizer. In a suitable embodiment, the product includes no gum stabilizer. Optionally, the product has a viscosity of about 50-350 cps; the product has a pH of about 6.3-7.3 (preferably 6.5-6.8); and the product includes about 20-500 ppm nisin or 20-200 ppm nisin. Optionally, the product includes no more than about 1.5%, 1.45%, 1.4%, 1.35%, 1.3%, 1.25%, 1.2%, 1.15%, 1.1%, 1.05%, or 1% (w/w) total carbohydrates. Preferably, the product includes no more than about 1.25% or 1.2% (w/w) total carbohydrates.

### EXAMPLES

### Example 1

High power ultrasound was used to prepare homogenized liquid egg products at relatively low temperature. Experiments were performed by using a 400 W ultrasound bench unit (i.e., a Hielscher UPS 400 Watt, 24 kHz (axial and radial probe). Several factors such as power, time, and ultrasonic probe type (axial or radial) were investigated with respect to the preparation of homogenized liquid egg products. Volume of supernatant after settling (48 hrs) and centrifugation (˜1800×g, for 5 minutes) was used as a performance measure.

Two hundred fifty ml of egg slurry was treated with ultrasonic energy at a constant temperature of about 4-10° C. (˜40-50° F.). Egg slurry may be formulated as described in Table 1.

TABLE 1
Exemplary Egg Slurry Formulations

| | | Formulation | | | | |
|---|---|---|---|---|---|---|
| | | 1.1 | 1.2 | 1.3 | 1.4 | 1.5 |
| Ingredient | Whole Eggs | 81.7 | 82.6 | 83.8 | 84.7 | 85.9 |
| (wt. %) | Water | ~18 | ~17 | ~16 | ~15 | ~14 |
| | Xanthan Gum HP | 0.15 | 0.2 | 0.2 | 0.2 | 0.1 |
| | TOTAL *^{,} ** | 100 | 100 | 100 | 100 | 100 |

* Acidifying agent (e.g., citric acid) may be added to adjust the pH to about 6.5-6.8.
** Nisin may be added to about 20-200 ppm.

The egg slurry of formulation 1.4 was treated by cooling the slurry to 1° C. (˜34° F.) and subjecting the cooled slurry to ultrasound of various power, time, and probe design with the parameters provided in Table 2.

TABLE 2
Ultrasonic Homogenization Parameters

| Parameter | Variable |
|---|---|
| Power (W) | 80, 240 400 (resp. 20, 60, 100%) |
| Time (s) | 10, 35, 60 |
| Probe | Axial (i.e., focused), or Radial |

The cooling temperature of the jacketed vessel was set at −10° C. (˜14° F.) to limit temperature rise during sonication. Samples had an average temperature between 2 and 4.5° C. (˜36-40° F.) during sonication.

After treatment, three 15 mL centrifuge tubes (per treatment parameter) were filled to provide samples. The samples were kept for 48 hours in the refrigerator. After allowing potential settling for 48 hours, the samples were centrifuged at 5000 rpm (˜1800×g) for 5 minutes and the volume of supernatant was recorded as an average of the three samples. The volume of the supernatant was then used to calculate a volume percentage relative to the total volume of the sample. For comparison, liquid egg samples that were homogenized by standard homogenization protocols using high shear at a relatively low temperature (i.e., 1-10° C. (˜34-50° F.) with a target temperature of about 2° C. (˜38° F.)) also were assessed.

The results were analyzed using software available from Stat-Ease, Inc. The results indicated that the smallest amount of settling was obtained by treating the egg slurry with high power (400 watts), for a long treatment time (60 seconds), using an axial probe. For all treatment times, the axial probe, which emits sound waves only at the bottom surface of the probe, performed better than the radial probe, which emits waves from all surfaces of the probe. Operating as such, the axial probe emitted a higher energy density than the radial probe as measured in watts per square centimeter. The volume of the active treatment zone below the axial probe was estimated to be approximately 10 ml. Treating 10 ml of egg slurry for approximately 2.4 seconds with an axial probe at 400 W power resulted in a product that demonstrated 0% settling.

### Example 2

The conditions required for treating larger volumes of egg slurry (i.e., scale-up conditions) may be estimated by considering (1) “energy input” (alternatively, “specific energy”); and (2) “energy density” (alternatively, “energy intensity”). Energy input requirements may be more influential in scale-up determinations than energy density, because energy density may be varied by selecting an appropriate probe design (e.g., an axial probe, which emits a higher energy density than a radial probe of equivalent energy).

Energy input (Wᵢₙₚᵤₜ) may be estimated based on the following formula:

Wᵢₙₚᵤₜ(kWh/L)=(W×T)/(3.6×10⁶(J/kWh)×V)
W=sonotrode power in watts
T=Treatment time in seconds
V=Volume of material treated

Under one set of conditions described in Example 1, (i.e., W=400 watts, T=60 seconds, and V=0.25 L), the energy input Wᵢₙₚᵤₜ is estimated as 0.001 kWh/L. Where Wᵢₙₚᵤₜ=0.001 kWh/L, the sonotrode power required to process 25,000 lbs/hour of egg slurry (i.e., 50 gallons/minute or 189 L/minute) is W=11.3 kilowatts. As such, scale-up conditions would be predicted to require a 10-20 kW ultrasonic unit.

### Example 3

A continuous ultrasonic pilot unit may be used to treat liquid egg formulations as prepared according to Table 3.

TABLE 3

| | | Formulation | | | | |
|---|---|---|---|---|---|---|
| | | 3.1 | 3.2 | 3.3 | 3.4 | 3.5 |
| Ingredient | Whole Eggs | 80.5 | 82.2 | 84.7 | 85.6 | 88.8 |
| (wt. %) | Water | ~19 | ~17 | ~15 | ~14 | ~11 |
| | Xanthan Gum HP | *** | *** | *** | *** | *** |
| | TOTAL *^{,} ** | 100 | 100 | 100 | 100 | 100 |

* Acidifying agent (e.g., citric acid) maybe added to adjust the pH to about 6.5-6.8.
** Nisin may be added to about 20-200 ppm.
*** Xanthan Gum HP may be added to about 0.2, 0.1, or 0.05 wt. %.

The ingredients are combined using a static mixer. A premix (few gallons) with a selected concentration of xanthan gum is prepared and diluted back into the 30 gallon tank to avoid clumps of the gum. Total mixing time is about 10 minutes and enough time is allowed for the xanthan gum to fully hydrate in the premix by turning the blender off and on again for several times.

Liquid egg compositions as provided by formulation 3.3 were processed at a low rate of about 1 gallon per minute (˜3.78 L/minute) through a continuous ultrasonic pilot unit that utilized a Hielscher 4 kW, 21 kHz, ultrasonic processor. The pilot unit consisted of an ultrasonic processor, a standard homogenizer, and a pasteurizer, all connected in sequence. The standard homogenizer was disabled for purposes of processing the egg formulations.

After processing, three 50 ml sample tubes were filled (per treatment parameter) to prepare samples. The samples were stored at 4° C. (˜40° F.) for 48 hours and then centrifuged at 5000 rpm (˜1800×g) for 5 minutes. The percentage volume of supernatant relative to the volume of the total sample was determined and an average percentage volume was calculated. The results are provided in Table 4.

TABLE 4

| | Xanthan Gum | | Supernatant |
|---|---|---|---|
| Sample | (wt. %) | Power (kW) | (volume %) |
| 1 | 0.2 | * | 10 |
| 2 | 0.2 | ** | 0 |
| 3 | 0.2 | 1.8 | 0 |
| 4 | 0.2 | 1.1 | 0 |
| 5 | 0.2 | 1.45 | 0 |
| 6 | 0.1 | * | 17 |
| 7 | 0.1 | ** | 5 |
| 8 | 0.1 | 1.65 | 3.3 |
| 9 | 0.1 | 1.0 | 6.6 |
| 10 | 0.1 | 1.35 | 5 |
| 11 | 0.05 | * | 70 |
| 12 | 0.05 | ** | 70 |
| 13 | 0.05 | 1.71 | 25 |
| 14 | 0.05 | 1.14 | 50 |
| 15 | 0.05 | 1.41 | 40 |
| 16 | 0.1 | ** | 5 |
| 17 | 0.1 | 1.65 | 2 |
| 18 | 0.1 | 1.4 | 3 |
| 19 | 0.1 | 2.0 | 0 |

* Non-homogenized
** Homogenized by high shear process

A few liters of samples 16-19 were subjected to taste studies. No substantial difference in taste was found between any of samples 16-19, except for sample 19 (treated with 2.0 kW power), which had a slightly metallic taste.

### Example 4

A Hielscher 400 Watt, 24 kHz axial lab probe is used to prepare homogenized liquid egg products using the exemplary formulations provided in Tables 5-7. The egg formulations may be prepared by combining the ingredients and blending repeatedly for 10 minutes. Any xanthan gum present in the formulation is allowed to fully hydrate prior to treating the formulation with ultrasound.

TABLE 5
Exemplary Liquid Egg Formulation 4.1

| Ingredient | Concentrations wt. % |
|---|---|
| Whole Eggs | 67-73 |
| Egg Whites | 10-15 |
| Water | 10-25 |
| Xanthan Gum | 0.1-0.2 |
| Nisaplin ® (Nisin) | 0.005-0.010 |
| TOTAL | 100 |

* Acidifying agent (e.g., citric acid) may be added to adjust the pH to about 6.5-6.8.

TABLE 6
Exemplary Liquid Egg Formulation 4.2

| Ingredient | Concentrations wt. % |
|---|---|
| Whole Eggs | 70-75 |
| Egg Whites | 10-15 |
| Water | 10-20 |
| Xanthan Gum | 0.1-0.2 |
| Nisaplin ® (Nisin) | 0.005-0.010 |
| TOTAL | 100 |

* Acidifying agent (e.g., citric acid) may be added to adjust the pH to about 6.5-6.8.

TABLE 7
Exemplary Liquid Egg Formulation 4.3

| Ingredient | Concentrations wt. % |
|---|---|
| Whole Eggs | ≧97.0 |
| Nisaplin ® (Nisin) | 0.005-0.010 |
| TOTAL | 100 |

* Acidifying agent (e.g., citric acid) may be added to adjust the pH to about 6.5-6.8.

Two hundred and fifty mL of the egg slurry is cooled to 1° C. (˜34° F.) and is treated with ultrasound (e.g., 35 seconds or 60 seconds at 400 Watts). The cooling temperature of the jacketed vessel may be set at −10° C. (˜14° F.) to limit temperature rise during sonication. Average sample temperature is maintained between 2 and 4.5° C. (˜36-40° F.) during sonication.

After treatment, three 15 mL centrifuge tubes (per treatment parameter) are filled to provide samples. The samples may be kept for 48 hours in the refrigerator. After allowing potential settling for 48 hours, the samples are centrifuged at 5000 rpm (˜1800×g) for 5 minutes and the volume of supernatant is recorded as an average of the three samples. The volume of the supernatant is then used to calculate a volume percentage relative to the total volume of the sample.

Exemplary egg formulations having ≧97.0 wt. % whole egg and treated with ultrasound for 60 seconds demonstrated no settling (i.e., no supernatant observed after centrifugation).

### Example 5

A Hielscher 400 Watt, 24 kHz axial lab probe may be used in this Example. Exemplary egg formulations 4.1 and 4.2 are prepared as provided in Table 5 and Table 6 with varying concentrations of xanthan gum (0.2, 0.15, or 0.1 wt. %). A total of 1 liter of each egg formulation is prepared by combining the ingredients and blending repeatedly for 10 minutes. The xanthan gum is allowed to fully hydrate. The formulations are placed at 4° C. (˜40° F.) for approximately 10 minutes to allow any entrapped air to escape.

Two hundred and fifty mL of each formulation is cooled to 1° C. (˜34° F.) and is treated with ultrasound for 35 seconds or 60 seconds at 100% power (400 Watts). The cooling temperature of the jacketed vessel is set at −10° C. (−14° F.) to limit temperature rise during sonication. Average sample temperature is maintained between 2 and 4.5° C. (˜36-40° F.) during sonication.

After treatment, three 15 mL centrifuge tubes (per treatment parameter) are filled to provide samples. The samples are kept for 48 hours in the refrigerator. After allowing potential settling for 48 hours, the samples are centrifuged at 5000 rpm (˜1800×g) for 5 minutes and the volume of supernatant is recorded as an average of the three samples. The volume of the supernatant is then used to calculate a volume percentage relative to the total volume of the sample.

Formulations having 0.2 wt. % xanthan gum demonstrated ≦1.7% settling (i.e., ≦1.7% supernatant volume) for 60 second treatment times. Formulations having 0.15 or 0.1 wt. % xanthan gum demonstrated ≦1.1% settling (i.e., ≦1.1% supernatant volume) for 60 second treatment times.

### Example 6

Homogenized liquid egg products prepared according to formulation 3.3 and treated with ultrasound as described in Example 3 were further analyzed with respect to particle characteristics. The observed particle characteristics were compared to the particle characteristics of a homogenized liquid egg product prepared according to formulation 3.3 that had not been subjected to ultrasonic treatment, (i.e., a homogenized liquid egg formulation that has been prepared by a process that included conventional mechanical shearing). Particle characteristics were measured using Powder WorkBench™ imaging software from Particle Characterization, Inc. (Iowa City, Iowa), and equivalent spherical diameter (ESD), aspect ratio (AIR), shape and sphericity were calculated. Results are presented in Table 8, where ESD, AIR, Shape, and Sphericity are presented as mean averages.

TABLE 8
Particle Characteristics of Homogenized Liquid Egg Products
Prepared According to Example 3, Formulation 3.3

| | | PARTICLE CHARACTERISTICS | | | |
|---|---|---|---|---|---|
| | | ESD (μm) | A/R | Shape | Sphericity |
| SAMPLE | D1 (0.2%, N/T) | 4.36 ± 3.19 | 0.72 ± 0.17 | 0.26 ± 0.04 | 0.65 ± 0.20 |
| | D2 (0.1%, 35 s) | 3.12 ± 1.56 | 0.60 ± 0.20 | 0.28 ± 0.03 | 0.52 ± 0.23 |
| | D3 (0.1%, 60 s) | 3.31 ± 2.11 | 0.57 ± 0.20 | 0.28 ± 0.03 | 0.46 ± 0.23 |
| | D4 (0.2%, 35 s) | 4.73 ± 3.64 | 0.64 ± 0.20 | 0.26 ± 0.04 | 0.53 ± 0.23 |

Homogenized sample (% xanthan gum, length of ultrasound treatment in seconds)
N/T—not treated with ultrasound

### Example 7

Homogenized liquid egg products prepared according to formulation 4.1 and treated with ultrasound as described in Example 4 were further analyzed with respect to particle characteristics. Ultrasound treated samples were treated for 35 seconds. Results are presented in Table 9.

TABLE 9
Particle Characteristics of Homogenized Liquid Egg Products
Prepared According to Example 4, Formulation 4.1

| | | PARTICLE CHARACTERISTICS | | | |
|---|---|---|---|---|---|
| | | ESD (μm) | A/R | Shape | Sphericity |
| SAMPLE | CB (0.2%, N/T) | 4.28 ± 2.79 | 0.66 ± 0.18 | 0.26 ± 0.04 | 0.56 ± 0.22 |
| | CB1 (0.1%) | 3.47 ± 2.03 | 0.63 ± 0.04 | 0.27 ± 0.04 | 0.53 ± 0.23 |
| | CB2 (0.2%) | 3.35 ± 1.82 | 0.61 ± 0.19 | 0.28 ± 0.03 | 0.52 ± 0.23 |

Homogenized sample (% xanthan gum)
N/T—not treated with ultrasound

### Example 8

Homogenized liquid egg products prepared according to formulation 4.3 and treated with ultrasound as described in Example 4 were further analyzed with respect to particle characteristics. Ultrasonically treated samples were treated for 35 seconds. Results are presented in Table 10.

TABLE 10
Particle Characteristics of Homogenized Liquid Egg Products
Prepared According to Example 4, Formulation 4.3

| | | PARTICLE CHARACTERISTICS | | | |
|---|---|---|---|---|---|
| | | ESD (μm) | A/R | Shape | Sphericity |
| SAMPLE | GN (not treated) | 4.34 ± 2.96 | 0.67 ± 0.17 | 0.26 ± 0.04 | 0.51 ± 0.21 |
| | GN (treated) | 6.27 ± 4.74 | 0.67 ± 0.17 | 0.25 ± 0.04 | 0.52 ± 0.20 |

All references, patents, and/or applications cited in the specification are incorporated by reference in their entireties, including any tables and figures, to the same extent as if each reference had been incorporated by reference in its entirety individually.

It will be readily apparent to one skilled in the art that varying substitutions and modifications may be made to the invention disclosed herein without departing from the scope and spirit of the invention. The invention illustratively described herein suitably may be practiced in the absence of any element or elements, limitation or limitations which is not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention. Thus, it should be understood that although the present invention has been illustrated by specific embodiments and optional features, modification and/or variation of the concepts herein disclosed may be resorted to by those skilled in the art, and that such modifications and variations are considered to be within the scope of this invention.

In addition, where features or aspects of the invention are described in terms of Markush groups or other grouping of alternatives, those skilled in the art will recognize that the invention is also thereby described in terms of any individual member, any subgroup of members of the Markush group or other group, or the totality of members of the Markush group or other group.

Also, unless indicated to the contrary, where various numerical values are provided for embodiments, additional embodiments are described by taking any 2 different values as the endpoints of a range. Such ranges are also within the scope of the described invention.

1. A homogenized liquid egg product comprising:
(a) about 60-90% (w/w) liquid whole egg; and
(b) no more than about 0. 15% (w/w) gum stabilizer;
wherein the product has a separation factor of no more than about 3% (v/v) after the product has been stored for at least about 2 days at a temperature of about 2-10° C. (˜34-50° F.).

2. The homogenized liquid egg product of claim 1, further comprising about 10-40% (w/w) water.

3. The homogenized liquid egg product of claim 1, comprising no more than about 0.1% (w/w) gum stabilizer.

4. The homogenized liquid egg product of claim 1, wherein the product has a viscosity of about 10-700 cps.

5. The homogenized liquid egg product of claim 1, further comprising about 5-20% (w/w) liquid egg white.

6. The homogenized liquid egg product of claim 1, further comprising about 0.5-3.0% (w/w) milk material.

7. The homogenized liquid egg product of claim 1, wherein the product comprises no more than about 1.25% (w/w) total carbohydrates.

8. (canceled)

9. (canceled)

10. (canceled)

11. A homogenized liquid egg product comprising:
(a) about 65-75% (w/w) liquid whole egg;
(b) about 10-20% (w/w) liquid egg white; and
(c) no more than about 0.15% (w/w) gum stabilizer;
wherein the product has a separation factor of no more than about 2.5% (v/v) after the product has been stored for at least about 2 days at a temperature of about 2-10° C. (˜34-50° F.).

12. The homogenized liquid egg product of claim 11, wherein the product has a viscosity of about 10-700 cps.

13. The homogenized liquid egg product of claim 11, further comprising about 0.5-3.0% (w/w) milk material.

14. The homogenized liquid egg product of claim 11, wherein the product comprises no more than about 1.1% (w/w) carbohydrates.

15. A homogenized liquid egg product comprising at least about 95% (w/w) liquid whole egg, wherein the product has a separation factor of no more than about 2.5% (v/v) after the product has been stored for at least about 5 days at a temperature of about 2-10° C. (˜34-50° F.).

16. The homogenized liquid egg product of claim 15, wherein the product has a viscosity of about 10-700 cps.

17. The homogenized liquid egg product of claim 15, wherein the product comprises no more than about 1.2% (w/w) total carbohydrates.

18. A method for preparing a homogenized liquid egg product comprising subjecting liquid egg material to sufficient ultrasonic energy to homogenize the liquid egg material, wherein the liquid egg material comprises at least about 60% (w/w) liquid whole egg.

19. The method of claim 18, wherein the homogenized liquid egg product has a separation factor of no more than about 3% (v/v) after the product has been stored for at least about 2 days at a temperature of about 2-10° C. (˜34-50° F.).

20. The method of claim 18, wherein the liquid egg product comprises no more than about 0.2% (w/w) gum stabilizer.

21. The method of claim 18, wherein the liquid egg material is subjected to about 1×10⁻⁴-1×10⁻¹ kilowatt-hour ultrasonic energy per liter liquid egg material.

22. (canceled)

23. (canceled)

24. (canceled)

25. The method of claim 18, wherein the liquid egg material comprises pasteurized liquid egg material.

26. The method of claim 18, wherein the homogenized liquid egg product has a viscosity of about 20-700 cps.

27. The method of claim 18, wherein the liquid egg material comprises about 80-90% (w/w) liquid whole egg.

28. The method of claim 18, wherein the liquid egg material comprises about 65-75% (w/w) liquid whole egg.

29. The method of claim 28, wherein the liquid egg material further comprises about 10-20% (w/w) liquid egg white.

30. (canceled)

31. (canceled)

32. A homogenized liquid egg product prepared by the method of claim 31.

33. A homogenized liquid egg product comprising:
(a) about 60-90% (w/w) liquid whole egg; and
(b) particles having at least one characteristic selected from:
(i) a mean equivalent spherical diameter of no more than 4.2 microns;
(ii) a mean aspect ratio of no more than 0.68; and
(iii) a mean sphericity of no more than 0.61;
wherein the product has a separation factor of no more than about 3% (v/v) after the product has been stored for at least about 2 days at a temperature of about 2-10° C. (˜34-50° F.).

34. (canceled)

35. (canceled)

36. (canceled)

37. (canceled)

38. (canceled)
